(19) United States
(12) Patent Application Publication
(10) Pub. No.: US 2026/0292156 A1
(43) Pub. Date: Sep. 24, 2026

(54) PARAMETER DERIVATION AND DIRECTION DETERMINATION FOR CONSTRAINED DIRECTIONAL ENHANCEMENT FILTER

(71) Applicant: Tencent America LLC, Palo Alto, CA (US)

(72) Inventors: Ting-Lan LIN, Palo Alto, CA (US); Liang ZHAO, Palo Alto, CA (US); Madhu PERINGASSERY KRISHNAN, Palo Alto, CA (US); Tianqi LIU, Palo Alto, CA (US); Shan LIU, Palo Alto, CA (US)

(21) Appl. No.: 19/373,581

(22) Filed: Oct. 29, 2025

Related U.S. Application Data
(60) Provisional application No. 63/774,661, filed on Mar. 19, 2025.

(51) Int. Cl. H04N 19/117; H04N 19/124; H04N 19/136; H04N 19/172; H04N 19/186; H04N 19/86

(52) U.S. Cl. CPC H04N 19/117; H04N 19/124; H04N 19/136; H04N 19/172; H04N 19/186; H04N 19/86

(57) ABSTRACT

An example method video coding includes receiving a video bitstream comprising a plurality of frames, including a current frame. A first direction for applying a first constrained directional enhancement filter (CDEF) to a first color component of the current frame is determined. The first direction is determined based on one or more of: a color format of the current frame, and pixels of the first color component. A second direction for applying a second CDEF to a second color component of the current frame, is determined. The second direction is determined based on one or more of: the color format of the current frame, and pixels of the second color component. The current frame is reconstructed by applying the first CDEF to the first color component and applying the second CDEF to the second color component.

### RELATED APPLICATIONS

This application claims priority to U.S. Provisional Patent Application No. 63/774,661, entitled “Damping parameter derivation and luma and chroma direction determination of Constrained Directional Enhancement Filter” filed Mar. 19, 2025, which is hereby incorporated by reference in its entirety.

### TECHNICAL FIELD

The disclosed embodiments relate generally to video coding, including but not limited to systems and methods for applying a Constrained Directional Enhancement Filter (CDEF).

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released.

### SUMMARY

The present disclosure describes techniques for direction determination for chroma and luma components of CDEF and techniques for deriving, instead of signaling, the damping factor of CDEF. The determinations for chroma U-plane CDEF filtering direction and chroma V-plane CDEF filtering direction may depend on the color format and/or the pixels in the chroma U- and chroma V-plane. By adapting directional filtering to the chroma sampling geometry (e.g., 4:2:0, 4:2:2, or 4:4:4), the filter can account for the geometric alignment and spatial offset between luma and chroma subsampling formats. By deriving the chroma filtering direction directly from local chroma pixel gradients, the CDEF filtering process more accurately follows true chroma edge orientations, reducing color misalignment and ringing artifacts while maintaining high coding efficiency across various subsampling formats. This adaptive approach improves the accuracy of directional filtering, reduces chroma ringing or misalignment artifacts, and enhances coding efficiency (e.g., by maintaining consistent filtering strength and orientation with the actual chroma content). In some embodiments, the damping factor is not explicitly signaled in the bitstream but instead is derived by the decoder, thereby reducing signaling overhead and simplifying syntax. In some embodiments, the derived damping factor can be calculated based on parameters such as the primary or secondary CDEF strengths. In some embodiments, determination of the luma plane filtering direction may depend on a defined squaring strategy and pixel shifting strategy. For example, for squaring strategy, pixel values are squared before summation (e.g., as opposed to after summation), thereby hereby yielding more accurate edge direction detection. In some embodiments, pixels are shifted based on a (a) bit depth, (b) subgroup statistics, and/or (c) the subgroup's average value, thereby yielding consistent and accurate edge direction detection and filtering performance.

In accordance with some embodiments, a method of video decoding is provided. The method includes receiving a video bitstream comprising a plurality of frames, including a current frame. The method includes, determining a first direction for applying a first CDEF to a first color component of the current frame, wherein the first direction is determined based on one or more of: a color format of the current frame, and pixels of the first color component. The method includes, determining a second direction for applying a second CDEF to a second color component of the current frame, wherein the second direction is determined based on one or more of: the color format of the current frame, and pixels of the second color component. The method includes, reconstructing the current frame by applying the first CDEF to the first color component and applying the second CDEF to the second color component.

In accordance with some embodiments, a method of video encoding is provided. The method includes receiving video data comprising a plurality of frames, including a current frame. The method includes, determining a first direction for applying a first CDEF to a first color component of the current frame, wherein the first direction is determined based on one or more of: a color format of the current frame, and pixels of the first color component. The method includes, determining a second direction for applying a second CDEF to a second color component of the current frame, wherein the second direction is determined based on one or more of: the color format of the current frame, and pixels of the second color component. The method includes, encoding the current frame by applying the first CDEF to the first color component and applying the second CDEF to the second color component.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder).

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIG. 4A illustrates example in-loop filtering stages in accordance with some embodiments.

FIG. 4B illustrates example edge directions in CDEF in accordance with some embodiments.

FIG. 4C illustrates example of chroma subsampling effect on direction in accordance with some embodiments.

FIG. 5A illustrates an example video decoding process in accordance with some embodiments.

FIG. 5B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes, amongst other things, video/image compression techniques for direction determination for chroma and luma components of CDEF, and techniques for deriving, instead of signaling, the damping factor of CDEF. In some embodiments, a video bitstream comprising a plurality of frames, including a current frame, is received. A first direction for applying a first CDEF filter to a first color component of the current frame is determined. The first direction is determined based on one or more of: a color format of the current frame, and pixels of the first color component. A second direction for applying a second CDEF filter to a second color component of the current frame is determined. The second direction is determined based on one or more of: the color format of the current frame, and pixels of the second color component. The current frame is reconstructed by applying the first CDEF to the first color component and applying the second CDEF to the second color component. By adapting directional filtering to the chroma sampling geometry (e.g., 4:2:0, 4:2:2, or 4:4:4) or to local chroma gradients, the filtering process more accurately follows true chroma edge orientations, reducing color misalignment and ringing artifacts while maintaining high coding efficiency across various subsampling formats.

Described herein are advanced techniques for determining the directional filtering of chroma and luma components in the CDEF used in video coding. For example, the direction for chroma filtering may be determined either by mapping from the luma direction using conversion arrays tailored to the color format, and/or by directly analyzing chroma pixel gradients, thereby allowing for more accurate alignment with true chroma edge orientations. Additionally, the techniques described herein include eliminating the need to explicitly signal the CDEF damping factor in the bitstream, instead deriving it at a decoding component based on parameters such as quantization index, bit depth, or CDEF strength. These techniques yield several benefits, including enhanced coding efficiency through more precise edge preservation and artifact reduction, improved visual quality by minimizing chroma misalignment and ringing, and reduced bitstream overhead due to the omission of explicit damping factor signaling. Collectively, these advancements provide a more adaptive and efficient in-loop filtering process that is robust across various chroma subsampling formats and video content types.

### Example Systems and Devices

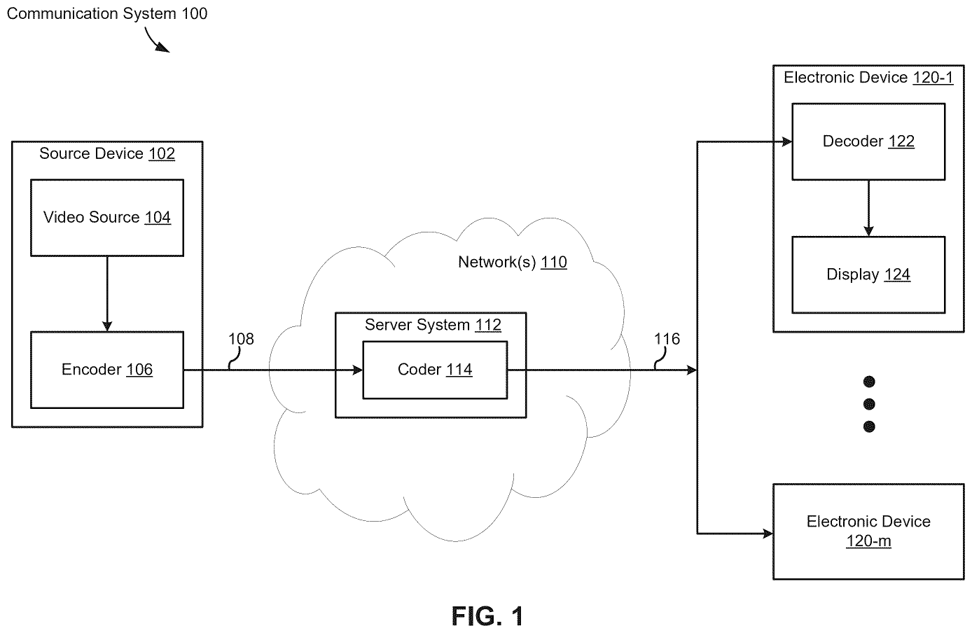

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

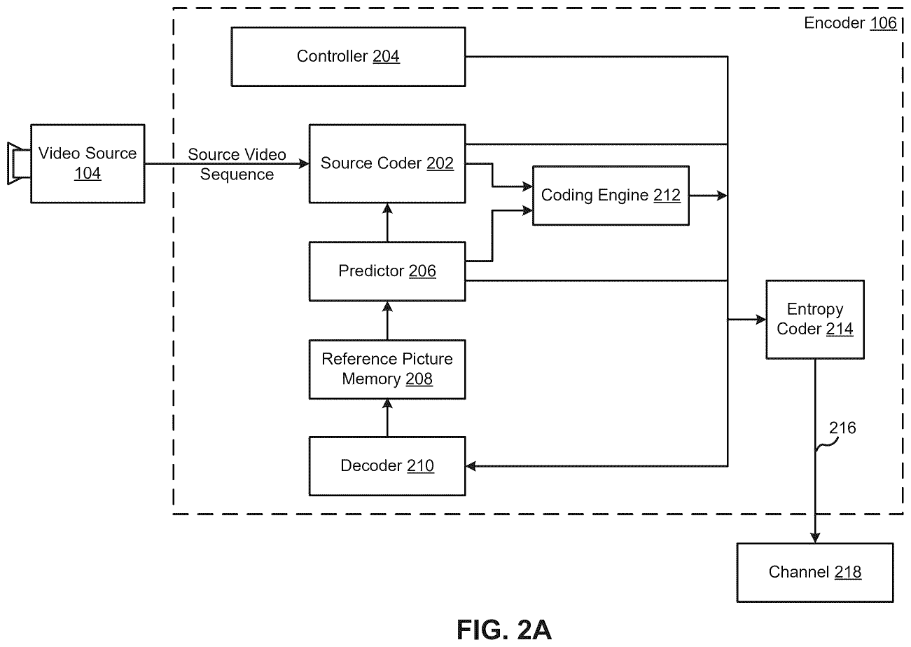

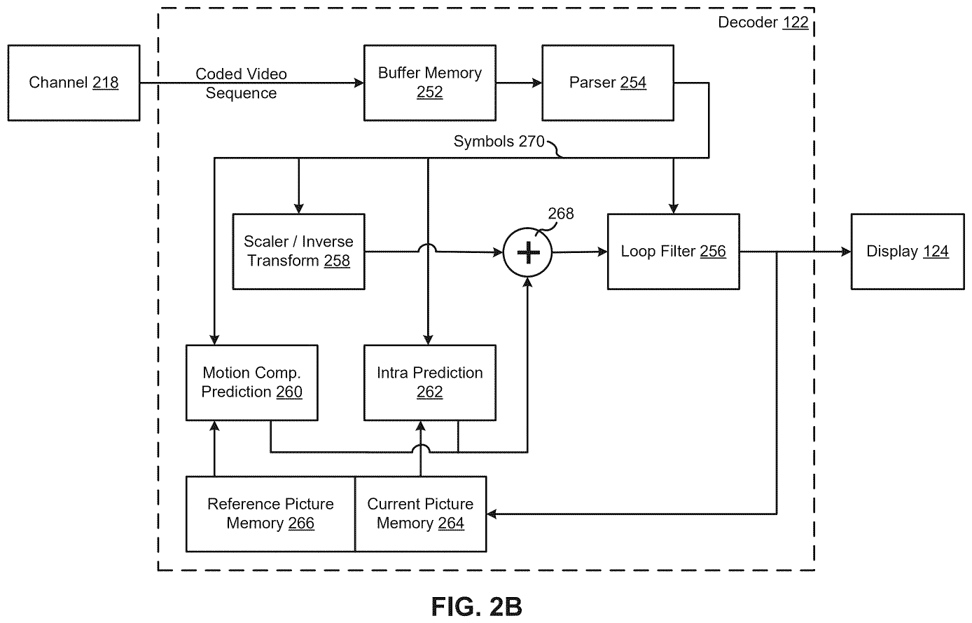

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268. In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation may also include interpolation of sample values as fetched from the reference picture memory 266, e.g., when sub-sample exact motion vectors are in use, motion vector prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

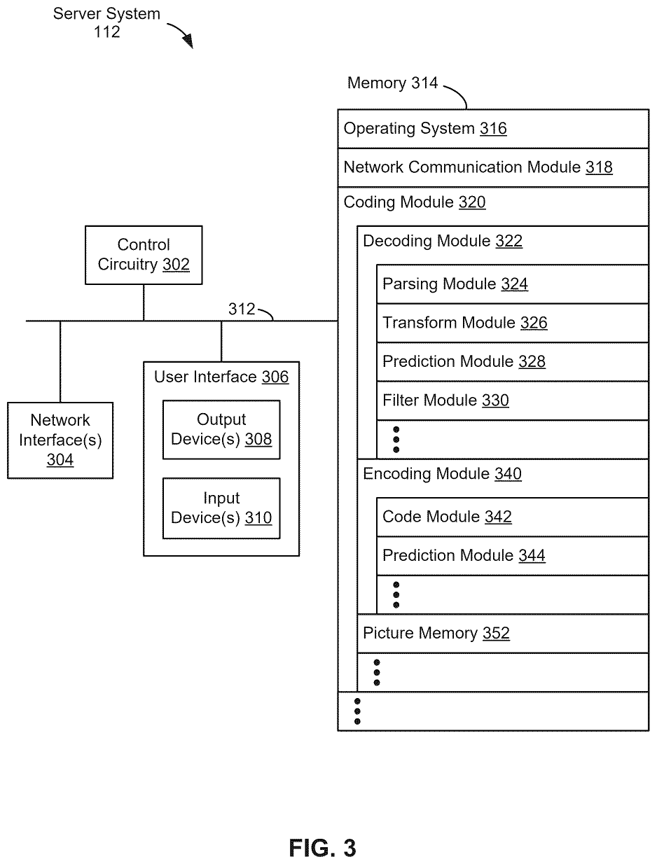

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). According to some embodiments, methods for signaling and applying CDEFs are described.

A CDEF is a non-linear in-loop filtering technique used in video coding systems to suppress ringing and other directional artifacts that may arise after block-based reconstruction. CDEF operates by identifying dominant edge directions within blocks of reconstructed pixels and applying adaptive filtering along those directions, thereby enhancing structural coherence and visual quality while preserving important image details. This filter is typically applied after deblocking and before other in-loop filters, contributing to improved perceptual quality and coding efficiency in modern video codecs.

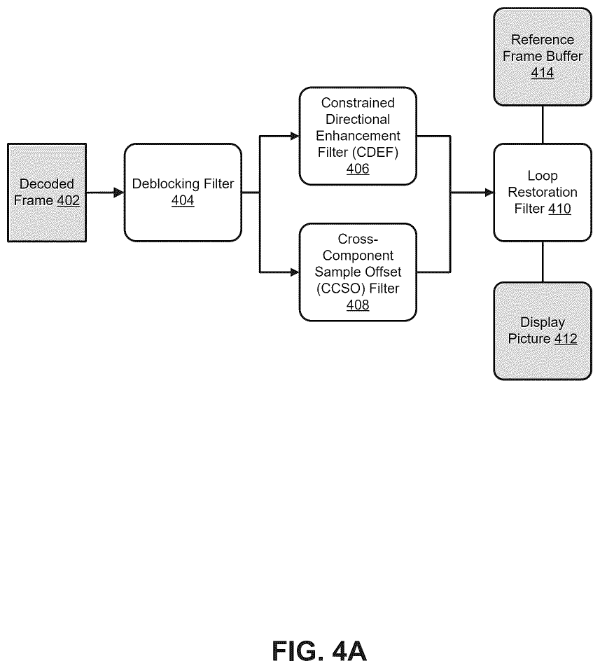

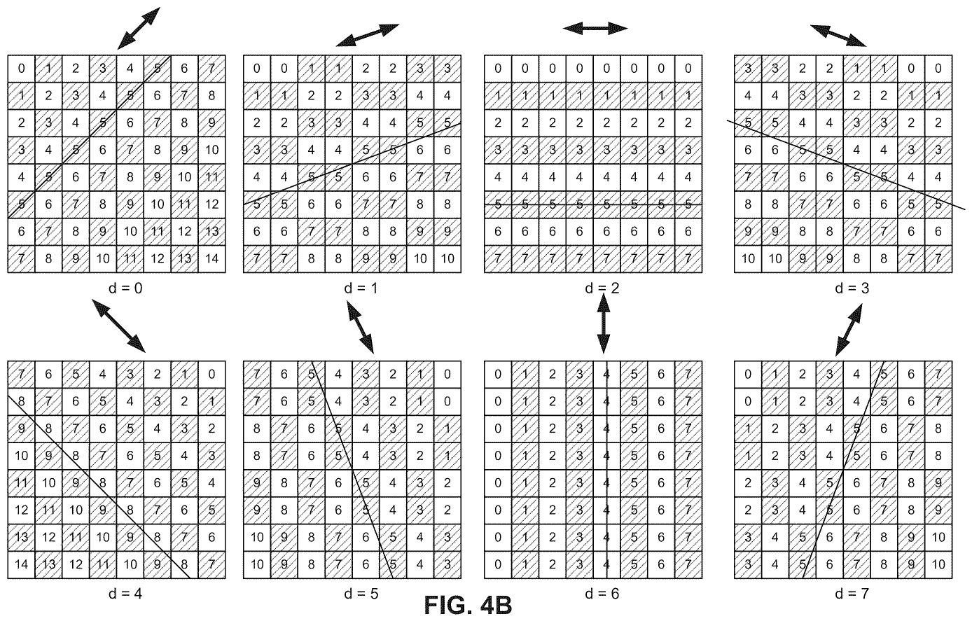

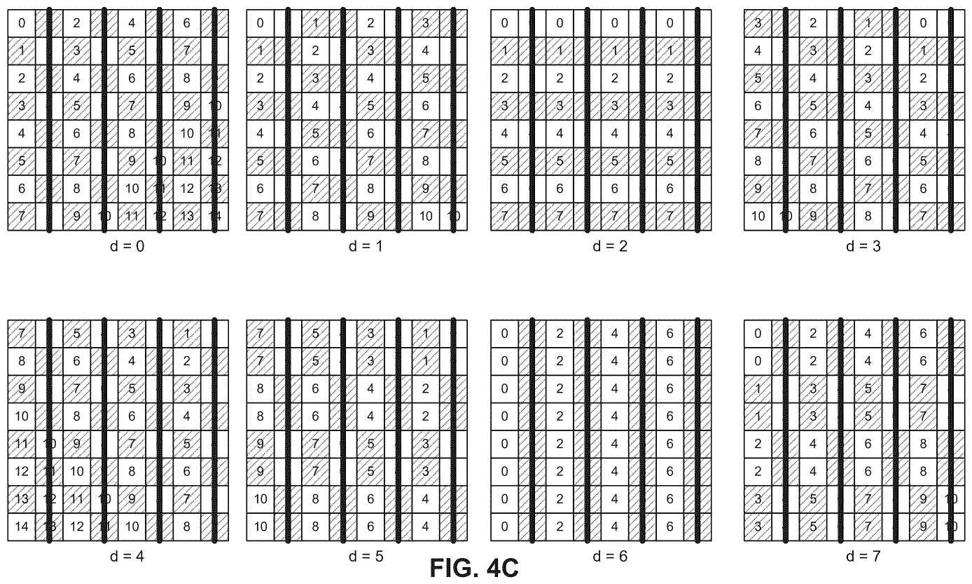

FIG. 4A illustrates example in-loop filtering stages in accordance with some embodiments. In the example of FIG. 4A, the in-loop filtering stages applied to the decoded frame 402 include a deblocking filter 404, a CDEF 406, a CCSO filter 408 and a loop restoration filter 410. In some embodiments, the filtered output frame is used as a reference frame for later frames (e.g., stored in a reference frame buffer 414). In some embodiments, a normative film grain synthesis stage is also applied to generate a corresponding displayed picture 412. Unlike the in-loop filter stages, the results of the film grain synthesis stage (e.g., an out-of-loop filter) does not influence the prediction for subsequent frames. The loop filtering methods may include any filtering process applied on the reconstructed samples (e.g., after adding residual to the prediction), including wiener loop filtering, cross-component filtering via the CCSO filter 408 and the CDEF 406.

The deblocking filter 404 is an in-loop filtering process configured to reduce visible discontinuities that occur along block boundaries as a result of block-based transform coding and quantization. In some embodiments, the deblocking filter 404 is applied across the transform block boundaries to remove block artifacts caused by the quantization error. The filter operates adaptively along horizontal and vertical edges of coded blocks, detecting discontinuities in pixel intensity across block boundaries and selectively smoothing those edges when the difference exceeds a context-dependent threshold. By reducing blocking artifacts in reconstructed frames prior to their use as reference frames for inter prediction, the deblocking filter improves both subjective visual quality and overall coding efficiency.

In some embodiments, filtering strength and direction are determined based on local coding parameters, such as quantization level, prediction mode, and motion information, to preserve true image edges while attenuating artificial ones. In some embodiments, a filter length is determined based on the minimum transform block sizes on both sides. In some embodiments, finite impulse response (FIR) filters (e.g., low-pass filters) are used by the deblocking filter 404. Edge detection may be used to disable the deblocking filter at transitions that contain a high variance signal (e.g., to avoid blurring an actual edge in the original image). In this way, a deblocking filtering method may be applied on reconstructions samples located close to block boundaries. The block boundaries may include a transform block boundary, a motion compensation block boundary, a coding block boundary, and/or a fixed block size boundary.

The CDEF 406 is an in-loop adaptive filtering process designed to suppress ringing and other directional artifacts that remain after block-based reconstruction. For each 8×8 block of reconstructed pixels, the filter identifies or determines a dominant edge direction based on local pixel gradients and applies directional filtering aligned the identified direction. For example, CDEF 406 applies filtering along the identified direction and to a lesser degree along directions rotated 45 degrees from the identified direction. In some embodiments, the filter strengths are signaled explicitly, which allows a high degree of control over the blurring. CDEF 406 uses weighted taps along primary and secondary directions, with a non-linear constraint function that limits the influence of pixels exhibiting large intensity differences, thereby preserving strong edges and textures. By enhancing structural coherence while avoiding over-smoothing, CDEF 406 improves perceptual quality and provides cleaner, directionally consistent reference frames for subsequent inter prediction stages.

In some embodiments, a CCSO filtering method uses (e.g., by applying CCSO filter 408) a co-located reconstructed sample and neighboring reconstructed samples from a first color component as input, to perform filtering of the current reconstruction sample of a second color component. In some embodiments, a CCSO filtering method may use (e.g., by applying CCSO filter 408) the co-located reconstructed sample and its neighboring reconstructed samples from a first color component as input, to derive an offset value that is added on the current sample of a second color component to adjust its reconstruction value. The first color component may refer to a luma color component, and the second color component may refer to a chroma color component. The first color component and second color component may be the same color component (e.g., a luma component). The CCSO filter 408 may produce offset values, which are added to the reconstructed samples of the luma and chroma components to reduce reconstruction error. In some embodiments, the CCSO filter 408 operates concurrently with the CDEF filter 406. For example, the reconstructed samples following deblocking 504 may be used as input for both the CDEF filter 406 and the CCSO filter 408.

In some embodiments, the loop restoration filter 410 is applied to reconstructed pixels after any prior in-loop filtering stages (e.g., the deblocking filter 404, the CDEF 406, and/or CCSO filter 408). The loop restoration filter 410 may be applied to loop restoration units (LRU), e.g., 64×64, 128×128, and/or 256×256 pixel blocks. Bypass filtering, a wiener filter (e.g., a wiener loop filtering method), and/or a self-guided filter may be applied to each LRU independently. A wiener loop filtering method may use a linear weighted sum of the current reconstruction sample and multiple spatially neighboring reconstruction samples as input to derive a modified value for the current reconstruction sample as the output.

As mentioned above, CDEF 406 filter is a non-linear in-loop filter to be performed on coded video after deblocking filter (e.g., to remove ringing/banding effect). As explained above, for each 8×8 block, CDEF 406 first performs direction detection, followed by filtering. The direction detection is performed on reconstructed pixels by computing against D direction patterns. In some embodiments, in CDEF 406, there are 8 possible predefined edge directions, corresponding to different angular slope (e.g., 0°, 45°, 90°, 135°, 22.5°, 67.5°, 112.5°, and) 157.5°, as illustrated in FIG. 4B.

For each 8×8 of d in FIG. 4B, the pixel (subtracted by 128) of the same index in an 8×8 are summed together, and the summed values are squared and multiplied by a division table for further processing, as illustrated in Table 1 below. The chroma plane does not perform the algorithm to determine direction. The chroma plane direction in 420 and 444 format directly use the decided direction of the associated luma 8×8 block, and the chroma plane direction in 422 and 440 format use the direction converted from the associated luma direction.

TABLE 1
The pixel operation for luma direction determination

```
int cdef_find_dir_c(const uint16_t *img, int stride, int32_t *var,
        int coeff_shift) {
int i;
int32_t cost[8] = { 0 };
int partial[8][15] = { { 0 } };
int32_t best_cost = 0;
int best_dir = 0;
/* Instead of dividing by n between 2 and 8, we multiply by 3*5*7*8/n.
    The output is then 840 times larger, but we don't care for finding
    the max. */
static const int div_table[ ] = { 0, 840, 420, 280, 210, 168,
140, 120, 105 };
for (i = 0; i < 8; i++) {
  int j;
  for (j = 0; j < 8; j++) {
    int x;
    /* We subtract 128 here to reduce the
    maximum range of the squared
      partial sums. */
  x = (img[i * stride + j] >> coeff_shift) − 128;
  partial[0][i + j] += x;
  partial[1][i + j / 2] += x;
  partial[2][i] += x;
  partial[3][3 + i − j / 2] += x;
  partial[4][7 + i − j] += x;
  partial[5][3 − i / 2 + j] += x;
  partial[6][j] += x;
  partial[7][i / 2 + j] += x;
  }
}
for (i = 0; i < 8; i++) {
  cost[2] += partial[2][i] * partial[2][i];
  cost[6] += partial[6][i] * partial[6][i];
}
cost[2] *= div_table[8];
cost[6] *= div_table[8];
```

For direction d (e.g., the identified dominant direction), a set of neighboring pixels corresponding to direction d are used for primary filter, and another set of neighboring pixels corresponding to 45° away from direction d are used for secondary filter. The filter coefficients and location of neighbors are associated with d. Primary strength and secondary strength (and a damping factor) are used in the computation of the nonlinear filtering on the difference between current pixel and a neighboring pixel for primary and secondary filter, and the result of the nonlinear filter is to be multiplied with the associated filter coefficient, and summed together with the original pixel, to be the final filtered pixel. The primary strength and secondary strength are combined into a strength for signaling, which is optionally 6-bits, deriving primary strength by strength/4 in range of 0~15, and deriving secondary strength by strength % 4 in range of 0, 1, 2, 3. All the 8×8 blocks within a 64×64 block share one strength. At frame-level, by considering all 64×64 blocks in a frame, a set of best strengths are found for the current frame and saved in cdef_strengths array for luma, and cdef_uv_strengths array for chroma, where these two arrays are of the same length. Each 64×64 block then uses a single index to select one CDEF strength from cdef_strengths array, and one CDEF uv strength from cdef_uv_strengths array.

For signaling, at frame level, a 1-bit cdef_frame_enable is signaled. If cdef_frame_enable is 1, signal 2-bit damping factor, and a 2-bit cdef_bit indicating the length of cdef_strengths array (and cdef_uv_strengths array) to be 2^{(cdef_bit)}. The elements in cdef_strengths array and cdef_uv_strengths array are then signaled (each element is 6-bit), as in Table 2 below, which illustrates example CDEF frame-level signaling.

TABLE 2
CDEF frame-level signaling

| | |
|---|---|
| cdef_frame_enable | (1) |
| if (!cdef_frame_enable) | |
| return | |
| cdef_damping | (2) |
| cdef_bits | (2) |
| nb_cdef_strengths = 1 << cdef_bits | |
| for i=0 to nb_cdef_strengths do | |
| cdef_strengths[i] | (6) |
| cdef_uv_strengths[i] | (6) |

If cdef_frame_enable is 1, at 64×64 block level, the index to the best CDEF strength (and CDEF uv strength) in the cdef_strengths array (and cdef_uv_strengths array) is signaled in cdef_bit bits, as illustrated in Table 3 below. Table 3 below illustrates CDEF 64×64 block-level signaling.

TABLE 3
CDEF 64 × 64 block-level signaling

| | |
|---|---|
| sb_cdef_strength | (cdef_bits) |

In conventional systems, the determination of direction of chroma block depends on conversions of the selected direction for luma 8×8 block, where the conversions depend on the chroma sampling types, as illustrated in Table 4 below. For example, if the direction of 8×8 luma is d=0, the corresponding 4×8 chroma U and V channels in chroma 422 format is d=7. The conversion array is formed based on the remaining pixel location after chroma sampling, as shown in FIG. 4C on how chroma 422 sampling affects direction, making the direction more vertical. FIG. 4C illustrates how chroma 422 sampling affects direction, where blocked locations are removed after sampling.

TABLE 4
Conversion arrays of direction of block to chroma block based on
luma 8 × 8 block. Conversions depend on chroma type 422 or 440

```
if (pli == 1 && xdec != ydec) {
  for (bi = 0; bi < cdef_count; bi++) {
    static const int conv422[8] = { 7, 0, 2, 4, 5, 6, 6, 6 };
    static const int conv440[8] = { 1, 2, 2, 2, 3, 4, 6, 0 };
    by = dlist[bi].by;
    bx = dlist[bi].bx;
    dir[by] [bx] = (xdec ? conv422 : conv440)[dir[by][bx]];
    }
}
```

Techniques for direction determinations for luma and chroma planes are described below. Additionally, techniques for deriving the damping factor, instead of being signaled, are described below.

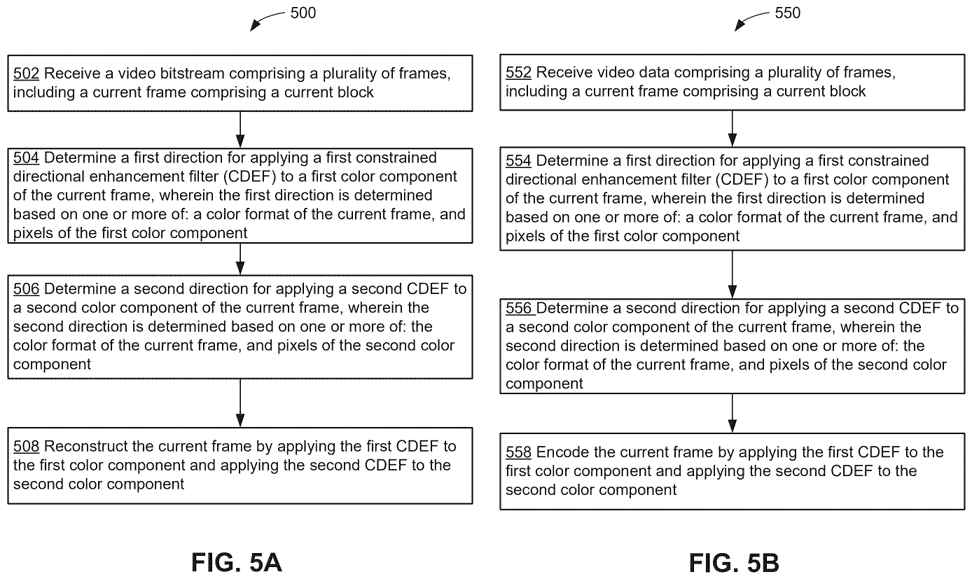

FIG. 5A is a flow diagram illustrating a method 500 of decoding video in accordance with some embodiments. The method 500 may be performed at a computing system (e.g., the server system 112, the source device 102, or the electronic device 120) having control circuitry and memory storing instructions for execution by the control circuitry. In some embodiments, the method 500 is performed by executing instructions stored in the memory (e.g., the memory 314) of the computing system.

The system receives (502) a video bitstream comprising a plurality of frames, including a current frame. The system determines (504) a first direction for applying a first CDEF to a first color component of the current frame. The first direction is determined based on one or more of: a color format of the current frame, and pixels of the first color component. The system determines (506) a second direction for applying a second CDEF to a second color component of the current frame, wherein the second direction is determined based on one or more of: the color format of the current frame, and pixels of the second color component. The system reconstructs (508) the current frame by applying the first CDEF to the first color component and applying the second CDEF to the second color component. In this way, the determinations for chroma U plane CDEF filtering direction and chroma V plane CDEF filtering direction may depend on the color format or the pixels in the chroma U and chroma V plane.

In some embodiments, the conversion of luma direction of chroma, depends on luma direction and the color format. In some embodiments, the conversion of luma direction to chroma avoids converging to vertical direction d=6, which means d=5 does not convert to 6 but stays as 5, and d=7 does not convert to 6 but stays as 7, to maintain the directionality. Therefore, the conversion array is {7, 0, 2, 4, 5, 5, 6, 7}. In some embodiments, the conversion of luma direction to chroma is identical, meaning that the chroma direction is the same as luma for 422. The conversion array is {0, 1, 2, 3, 4, 5, 6, 7}.

In some embodiments, the chroma direction is determined by performing the direction detection algorithm directly on chroma pixels instead of being converted from luma direction. All the preceding techniques described above for luma can be used for chroma. In one example, the direction detection method can be the same as the luma detection method. In one example, a gradient based direction detection method can be applied.

In some embodiments, all the preceding techniques described above can be applied to different chroma U and V plane independently with different combinations. In some embodiments, all the preceding techniques described above can be applied to different chroma sampling formats. In some embodiments, all the preceding techniques described above can be applied to chroma sampling formats 420. In some embodiments, all the preceding techniques described above can be applied to chroma sampling formats 422. In some embodiments, all the preceding techniques described above can be applied to chroma sampling formats 440. In some embodiments, all the preceding techniques described above can be applied to chroma sampling formats 444.

In some embodiments, the damping factor is not signaled. Instead, the damping factor can be derived by the decoder. In some embodiments, the damping factor is not signaled. Instead, the damping factor can be derived by the decoder based on base quantization index and sequence bit depth, as illustrated in Table 5 below. Table 5 below shows derivation of CDEF damping factor in decoder.

TABLE 5
Derivation of CDEF damping factor in decoder

```
#if CONFIG_CDEF_DAMPING_NO_SIGNAL
  int damping_offset =
    clamp(cm->quant_params.base_qindex -
        (cm->seq_params.bit_depth == AOM_BITS_8 ? 0
          : cm->seq_params.bit_depth == AOM_BITS_10 ? 2 *
          MAXQ_OFFSET
            : 4 * MAXQ_OFFSET),
      MINQ, MAXQ_8_BITS) >>
    6;
  cdef_info->cdef_damping = AOMMIN(3 + damping_offset, 6);
#else //CONFIG_CDEF_DAMPING_NO_SIGNAL
  cdef_info->cdef_damping = aom_rb_read_literal(rb, 2) + 3;
#endif // CONFIG_CDEF_DAMPING_NO_SIGNAL
```

In some embodiments, the damping factor is derived based on the base_qindex and/or the bit depth of current frame/sequence.

In some embodiments, the damping factor is not signaled. Instead, the damping factor can be derived by the decoder based on the CDEF strength selected for the luma/chroma block.

In some embodiments, the damping factor is not signaled. Instead, the damping factor can be derived by the decoder based on the CDEF primary strength selected for the luma/chroma block.

In some embodiments, the damping factor is not signaled. Instead, the damping factor can be derived by the decoder based on the CDEF secondary strength selected for the luma/chroma block.

In some embodiments, the damping factor is not signaled. Instead, the damping factor can be derived by the decoder based on the CDEF direction determined for the luma/chroma block.

In some embodiments, the damping factor is not signaled. Instead, the damping factor is a constant. In one example, the damping factor is 0.

In some embodiments, the CDEF direction determination for luma plane direction depends on squaring strategy and pixel shifting strategy. In some embodiments, for squaring strategy, the pixels are squared before summation for each location index in a specific d=0~7. (as opposed to squaring after summation as in conventional systems), as illustrated in Table 6 below.

```
TABLE 6
int cdef_find_dir_c_uv(const uint16_t *img, int stride, int32_t *var,
          int coeff_shift) {
  int i;
  int32_t cost[8] = { 0 };
+ int32_t partial[8][11] = { { 0 } };
  int32_t best_cost = 0;
  int best_dir = 0;
  static const int div_table[ ] = { 0, 840, 420, 280, 210, 168,
  140, 120, 105 };
  for (int i = 0; i < 8; i++) {
    for (int j = 0; j < 4; j++) {
        int x = ((img[i * stride + j]) >> coeff_shift) − 128;
+ partial[0][i + j] += x*x;
+ partial[1][i + j/2] += x*x;
+ partial [2][i] += x*x;
+ partial[3][1+ i − (j/2)] += x*x;
+ partial[4][3 + i − j] += x*x;
+ partial[5][3 + (i/2) − j] += x*x; ///////////
+ partial[6][j] += x*x;
+ partial[7][(i/2) + j] += x*x;
    }
  }
      for (int k = 0; k < 4; k++) {
        cost[2] += partial[2][k] ;
        cost[6] += partial[6][k] ;
```

In some embodiments, for shifting strategy, the pixels are not shifted. In one example, the pixels are not subtracted by 128 before processing.

In some embodiments, for shifting strategy, the pixels are shifted based on bitdepth of the sequence. In some embodiments, the pixels are subtracted by (1<<bitdepth)/2 before processing. In one example, for 10-bit sequence, the pixels are subtracted by (1<<10)/2=512 before processing.

In some embodiments, for shifting strategy, the pixels are shifted based on the statistic of the subgroup i (indexed by the number in a 8×8 block for a d in FIG. 4B) in which the pixels are in. In some embodiments, for shifting strategy, the pixels are shifted by the average value of the subgroup i (indexed by the number in a 8×8 block for a d in FIG. 4B) in which the pixels are in.

FIG. 5B is a flow diagram illustrating a method 550 of encoding video in accordance with some embodiments. The method 550 may be performed at a computing system (e.g., the server system 112, the source device 102, or the electronic device 120) having control circuitry and memory storing instructions for execution by the control circuitry. In some embodiments, the method 550 is performed by executing instructions stored in the memory (e.g., the memory 314) of the computing system. In some embodiments, the method 550 is performed by a same system as the method 550 described above.

The system receives (552) video data comprising a plurality of frames, including a current frame. The system determines (554) a first direction for applying a first CDEF to a first color component of the current frame, wherein the first direction is determined based on one or more of: a color format of the current frame, and pixels of the first color component. The system determines (556) a second direction for applying a second CDEF to a second color component of the current frame, wherein the second direction is determined based on one or more of: the color format of the current frame, and pixels of the second color component. The system encodes (558) the current frame by applying the first CDEF to the first color component and applying the second CDEF to the second color component. As described previously, the encoding process may mirror the decoding processes described herein (e.g., CDEF). For brevity, those details are not repeated here.

Although FIGS. 5A and 5B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.
(A1) In one aspect, some embodiments include a method (e.g., the method 500) of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream (e.g., a coded video sequence) comprising a plurality of frames, including a current frame; (ii) determining a first direction for applying a first CDEF to a first color component of the current frame, wherein the first direction is determined based on one or more of: a color format of the current frame, and pixels of the first color component; (iii) determining a second direction for applying a second CDEF to a second color component of the current frame, wherein the second direction is determined based on one or more of: the color format of the current frame, and pixels of the second color component; and (iv) reconstructing the current frame by applying the first CDEF to the first color component and applying the second CDEF to the second color component. In this way, the determinations for chroma U plane CDEF filtering direction and chroma V plane CDEF filtering direction may depend on the color format or the pixels in the chroma U and chroma V plane. In this way, the determinations for chroma U plane CDEF filtering direction and chroma V plane CDEF filtering direction may depend on the color format or the pixels in the chroma U and chroma V plane.
(A2) In some embodiments of A1, the second direction is determined based on the first direction and the color format of the current frame. For example, the conversion of luma direction to chroma, may depend on luma direction and the color format. In some embodiments, different mappings are used for different color formats. Allowing the conversion of luma direction to chroma to depend on both the luma direction and the color format enables accurate directional alignment across varying chroma subsampling schemes, improving filtering precision and reducing artifacts while maintaining low signaling complexity.
(A3) In some embodiments of A2, the second direction is determined using a conversion array. For example, the conversion of luma direction to chroma avoid converging to vertical direction d=6, which means d=5 do not convert to 6 but stay as 5, and d=7 do not convert to 6 but stay as 7, to maintain the directionality. Therefore, the conversion array may be {7, 0, 2, 4, 5, 5, 6, 7}. As another example, for the 4:2:2 format, the conversion of luma direction to chroma is identical, meaning that the chroma direction is the same as luma. The conversion array may be {0, 1, 2, 3, 4, 5, 6, 7}.
(A4) In some embodiments of any of A1-A3, the second direction is determined by applying a direction detection technique to the pixels of the second color component. For example, the chroma direction is determined by performing the direction detection algorithm directly on chroma pixels instead of being converted from luma direction. As an example, the direction detection method can be the same as the luma detection method. As another example, a gradient-based direction detection method can be applied. Determining the chroma direction directly from chroma pixels improves filtering accuracy by capturing chroma-specific edge orientations and color transitions that may not align with luma-derived directions, thereby enhancing chroma fidelity and reducing color artifacts.
(A5) In some embodiments of any of A1-A4, the method includes, determining a third direction for applying a third CDEF to a third color component of the current frame, wherein the third direction is determined based on one or more of: the color format of the current frame, and pixels of the third color component. For example, the techniques and details described above can be applied to different chroma U and V planes.
(A6) In some embodiments of any of A1-A5, the color format of the current frame is one of: a 4:2:0 format; a 4:2:2 format; a 4:4:0 format; and a 4:4:4 format. For example, the techniques and details described above can be applied to different chroma sampling formats. As an example, all above can be applied to chroma sampling formats 4:2:0, 4:2:2, 4:4:0, and/or 4:4:4.
(A7) In some embodiments of any of A1-A6, the method includes, deriving a damping factor for the first CDEF, wherein the damping factor is not signaled in the video bitstream. For example, the damping factor is not signaled. Instead, the damping factor can be derived by the decoder. In some embodiments, the damping factor is a constant (e.g., a predefined value). For example, the damping factor may be set equal to 0. In some embodiments, the second direction is determined based on the first direction, and the damping factor is derived at the decoding component. Deriving the damping factor at the decoder instead of signaling it reduces bitstream overhead and simplifies syntax.
(A8) In some embodiments of A7, the damping factor is derived based on one or more of: a quantization index for the current frame, and a sequence bit depth used for the current frame. For example, the damping factor is not signaled. Instead, the damping factor can be derived by the decoder based on base quantization index and sequence bit depth, as shown above in Table 5. As an example, the damping factor is derived based on the base_qindex and/or the bit depth of current frame/sequence.
(A9) In some embodiments of A7, the damping factor is derived based on a CDEF strength for the first CDEF. For example, the damping factor is not signaled. Instead, the damping factor can be derived by the decoder based on the CDEF strength selected for the luma/chroma block. As another example, the damping factor can be derived by the decoder based on the CDEF primary strength selected for the luma/chroma block. As another example, the damping factor can be derived by the decoder based on the CDEF secondary strength selected for the luma/chroma block. Deriving the damping factor from the CDEF primary strength or secondary strength selected for the luma/chroma block enables adaptive filtering strength control without additional signaling, reducing bitstream size while improving coding efficiency.
(A10) In some embodiments of A7, the damping factor is derived based on the first direction. For example, the damping factor can be derived by the decoder based on the CDEF direction determined for the luma/chroma block.
(A11) In some embodiments of any of A1-A10, the first direction is determined using one or more of: a pixel squaring technique, and a pixel shifting technique. For example, the CDEF direction determination for luma plane direction depends on squaring strategy and pixel shifting strategy. As an example, for squaring strategy, the pixels may be squared before summation for each location index in a specific d=0~7 (as opposed to squaring after summation). In some embodiments, the pixel shifting technique consists of not shifting pixels. For example, for shifting strategy, the pixels are not shifted. As an example, the pixels are not subtracted by 128 before processing, as is done in some conventional systems. In some embodiments, the pixel shifting technique comprises shifting the pixels based on a bit depth of the sequence. For example, for shifting strategy, the pixels are shifted based on bitdepth of the sequence. As an example, the pixels are subtracted by (1<<bitdepth)/2 before processing. As another example, for 10-bit sequence, the pixels are subtracted by (1<<10)/2=512 before processing. In some embodiments, the pixel shifting technique comprises shifting the pixels based on which subgroup the pixels are in. For example, for shifting strategy, the pixels are shifted based on the statistic of the subgroup i (indexed by the number in a 8×8 block for a din FIG. 4B) in which the pixels are in. As an example, for shifting strategy, the pixels are shifted by the average value of the subgroup i (indexed by the number in a 8×8 block for a d in FIG. 4B) in which the pixels are in.
(B1) In another aspect, some embodiments include a method (e.g., the method 550) of video encoding. In some embodiments, the method is performed at a computing system (e.g., the server system 112) having memory and control circuitry. In some embodiments, the method is performed at a coding module (e.g., the coding module 320). The method includes: (i) receiving video data (e.g., a source video sequence) comprising a plurality of frames, including a current frame; (ii) determining a first direction for applying a first CDEF to a first color component of the current frame, wherein the first direction is determined based on one or more of: a color format of the current frame, and pixels of the first color component; (iii) determining a second direction for applying a second CDEF to a second color component of the current frame, wherein the second direction is determined based on one or more of: the color format of the current frame, and pixels of the second color component; and (iv) encoding the current frame by applying the first CDEF to the first color component and applying the second CDEF to the second color component. In some embodiments, the method further includes transmitting encoded information for the current frame in a video bitstream.
(B2) In some embodiments of B1, the second direction is determined based on the first direction and the color format of the current frame.
(B3) In some embodiments of B1 or B2, the second direction is determined by applying a direction detection technique to the pixels of the second color component.
(B4) In some embodiments of any of B1-B3, the method includes, determining a third direction for applying a third CDEF to a third color component of the current frame, wherein the third direction is determined based on one or more of: the color format of the current frame, and pixels of the third color component.
(B5) In some embodiments of any of B1-B4, deriving a damping factor for the first CDEF, wherein the damping factor is not signaled in the video bitstream.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A11 and B1-B5).

In yet another aspect, some embodiments include a non-transitory computer-readable storage medium storing one or more sets of instructions for execution by control circuitry of a computing system, the one or more sets of instructions including instructions for performing any of the methods described herein (e.g., A1-A11 and B1-B5 above). In some embodiments, a memory or non-transitory computer-readable storage medium stores a video bitstream including any of the features (e.g., syntax and encoded information) disclosed herein.

Unless otherwise specified, any of the syntax elements (e.g., indicators) described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of frames, including a current frame;
determining a first direction for applying a first constrained directional enhancement filter (CDEF) to a first color component of the current frame, wherein the first direction is determined based on one or more of: a color format of the current frame, and pixels of the first color component;
determining a second direction for applying a second CDEF to a second color component of the current frame, wherein the second direction is determined based on one or more of: the color format of the current frame, and pixels of the second color component; and
reconstructing the current frame by applying the first CDEF to the first color component and applying the second CDEF to the second color component.

2. The method of claim 1, wherein the second direction is determined based on the first direction and the color format of the current frame.

3. The method of claim 2, wherein the second direction is determined using a conversion array.

4. The method of claim 1, wherein the second direction is determined by applying a direction detection technique to the pixels of the second color component.

5. The method of claim 1, further comprising determining a third direction for applying a third CDEF to a third color component of the current frame, wherein the third direction is determined based on one or more of: the color format of the current frame, and pixels of the third color component.

6. The method of claim 1, wherein the color format of the current frame is one of:
a 4:2:0 format;
a 4:2:2 format;
a 4:4:0 format; and
a 4:4:4 format.

7. The method of claim 1, further comprising deriving a damping factor for the first CDEF, wherein the damping factor is not signaled in the video bitstream.

8. The method of claim 7, wherein the damping factor is derived based on one or more of: a quantization index for the current frame, and a sequence bit depth used for the current frame.

9. The method of claim 7, wherein the damping factor is derived based on a CDEF strength for the first CDEF.

10. The method of claim 7, wherein the damping factor is derived based on the first direction.

11. The method of claim 1, wherein the first direction is determined using one or more of: a pixel squaring technique, and a pixel shifting technique.

12. A method of video encoding performed at a computing system having memory and one or more processors, the method comprising:
receiving video data comprising a plurality of frames, including a current frame;
determining a first direction for applying a first constrained directional enhancement filter (CDEF) to a first color component of the current frame, wherein the first direction is determined based on one or more of: a color format of the current frame, and pixels of the first color component;
determining a second direction for applying a second CDEF to a second color component of the current frame, wherein the second direction is determined based on one or more of: the color format of the current frame, and pixels of the second color component; and
encoding the current frame by applying the first CDEF to the first color component and applying the second CDEF to the second color component.

13. The method of claim 12, wherein the second direction is determined based on the first direction and the color format of the current frame.

14. The method of claim 12, wherein the second direction is determined by applying a direction detection technique to the pixels of the second color component.

15. The method of claim 12, further comprising determining a third direction for applying a third CDEF to a third color component of the current frame, wherein the third direction is determined based on one or more of: the color format of the current frame, and pixels of the third color component.

16. The method of claim 12, further comprising deriving a damping factor for the first CDEF, wherein the damping factor is not signaled in the video bitstream.

17. A non-transitory computer-readable storage medium storing a video bitstream that is generated by a video encoding method, the video bitstream comprising:
coded information for a plurality of frames including a current frame; and
wherein the video encoding method comprises:
determining a first direction for applying a first constrained directional enhancement filter (CDEF) to a first color component of the current frame, wherein the first direction is determined based on one or more of: a color format of the current frame, and pixels of the first color component;
determining a second direction for applying a second CDEF to a second color component of the current frame, wherein the second direction is determined based on one or more of: the color format of the current frame, and pixels of the second color component; and
encoding the current frame by applying the first CDEF to the first color component and applying the second CDEF to the second color component.

18. The non-transitory computer-readable storage medium of claim 17, wherein the second direction is determined based on the first direction and the color format of the current frame.

19. The non-transitory computer-readable storage medium of claim 17, wherein the second direction is determined by applying a direction detection technique to the pixels of the second color component.

20. The non-transitory computer-readable storage medium of claim 17, wherein the video encoding method further comprises deriving a damping factor for the first CDEF, and wherein the video bitstream does not include an indicator for the damping factor.
